(19) United States
(12) Patent Application Publication
(10) Pub. No.: US 2025/0272388 A1
(43) Pub. Date: Aug. 28, 2025

(54) RANSOMWARE PROTECTION FOR ARCHIVED DATA

(71) Applicant: OPEN TEXT SA ULC, Halifax (CA)

(72) Inventor: Andreas Sellmeier, Baldham (DE)

(21) Appl. No.: 18/590,668

(22) Filed: Feb. 28, 2024

(51) Int. Cl. G06F 21/55; G06F 16/11

(52) U.S. Cl. CPC G06F 21/554; G06F 16/113; G06F 16/125; G06F 2221/034

(57) ABSTRACT

A computer-implemented method for protection of archival data is provided. The computer-implement method can comprise creating a first version of an object in an anti-attack store and storing an archival file in the object in the anti-attack store. The anti-attack store has associated anti-attack functionality triggerable based on detecting an attempted change to the object in the anti-attack store. The associated anti-attack functionality comprises automatically creating a new version of the object and automatically applying a retention lock to the first version of the object without applying the attempted change to the first version of the object, the retention lock specifying a retention period for the first version of the object.

### TECHNICAL FIELD

This disclosure relates generally to network data security. More specifically, this disclosure relates to protecting stored data against ransomware attacks.

### BACKGROUND

The exponential growth of data in the digital age has become a ubiquitous challenge for organizations. The need to retain data for legal, regulatory, and business reasons, along with the failure of users to cull redundant and obsolete data, results in the retention of vast amounts of data that is rarely accessed. This accumulation of data contributes to storage inefficiency and complicates data management tasks.

Data archiving systems, such as file archiving systems, aim to address these challenges by providing an intelligent, policy-driven approach to the categorization and storage of data. These systems implement policies to store rarely used or old data to archive storage that is typically cheaper, but slower to access, than the stores used for more active files. By segregating active data from archival data, data archiving systems optimize storage utilization and contribute to overall system performance. In addition to storage optimization, data archiving systems can include features to ensure data security and compliance.

In recent years, organizations have experienced an alarming rise in the prevalence and sophistication of ransomware attacks. Ransomware encrypts a user's files or entire systems, rendering them inaccessible until a ransom is paid to the attacker. Cloud-based file storage systems are not immune from ransomware and other cyberattacks. This poses a threat to data archiving systems that store archival files in cloud storage. Current strategies for addressing a ransomware attack without paying the ransom rely on restoring files from a backup made before the attack. This type of response, however, assumes that a backup is available, and that the backup was not affected by the attack. Often, however, there is no separate backup of archival data.

As such, there is a need for improved methods of protecting files from ransomware or other cyber-attacks.

### SUMMARY

Embodiments of the present disclosure provide systems, methods, and computer program products for protecting archived data from cyberattacks, such as ransomware attacks. Embodiments can utilize an anti-attack archive store, such as an anti-attack container provided by a cloud storage system. The anti-attack store has associated anti-attack functionality enabled including versioning and automatic application of retention locks. According to one embodiment, an attempted change to an object in the anti-attack store causes the anti-attack store to create a new version of the object and automatically assert a retention lock on the old version of the object. The anti-attack store can further send a notification to an information technology operations system or other system to trigger a remedial action.

One general aspect includes a computer-implemented method for protection of archival data against cyberattacks. The method includes creating a first version of an object in an anti-attack store and storing an archival file in the object in the anti-attack store. The anti-attack store may include, in some embodiments, an anti-attack container on a cloud storage system. The anti-attack store has associated anti-attack functionality triggerable based on detecting an attempted change to the object in the anti-attack store enabled. The associated anti-attack functionality may include: automatically creating a new version of the object; and automatically applying a retention lock to the first version of the object without applying the attempted change to the first version of the object, the retention lock specifying a retention period for the first version of the object. The attempted change may be made to the new version of the object.

Another general aspect includes a non-transitory, computer-readable medium storing computer-translatable instructions, the computer-translatable instructions comprising instructions for creating a first version of an object in an anti-attack store and storing an archival file in the object in the anti-attack store. The anti-attack store may include, in some embodiments, an anti-attack container on a cloud storage system. The anti-attack store has associated anti-attack functionality triggerable based on detecting an attempted change to the object in the anti-attack store. The associated anti-attack functionality may include automatically creating a new version of the object and automatically applying a retention lock to the first version of the object without applying the attempted change to the first version of the object, the retention lock specifying a retention period for the first version of the object.

Another general aspect includes a network system for data archiving that includes a storage component and a data archiving computer system coupled to the storage component. The data archiving computer system may comprise a data archiving system executable to access an anti-attack container of a cloud storage system; and store an archival file as a first version of an object in the anti-attack container. In some embodiments, the anti-attack container is a container on a cloud storage system. The anti-attack container has associated anti-attack functionality triggerable based on an attempted change to the object. The associated anti-attack functionality may include automatically creating a new version of the object in the anti-attack container and automatically applying a retention lock to the first version of the object without applying the attempted change to the first version of the object, the retention lock specifying a retention period for the first version of the object. The network system may further include an information technology operations system comprising instructions executable to receive a notification from the cloud storage system of an event associated with the object and execute a remedial action in response to the notification.

In some embodiments, the anti-attack functionality further may include sending a notification of an event associated with the attempted change to a target. The notification of the event associated with the attempted change may include a notification that the new version of the object has been created. According to one embodiment, the notification of the event associated with the attempted change triggers a remedial action. The remedial action, according to one embodiment, includes one or more of blocking a connection, scanning an environment for attacker code, investigating entry points for attacker code, removing attacker code, restoring the first version of the object as a current version of the object, or deleting the new version of the object.

Embodiments of the present disclosure provide protection against cyberattacks for archived data without requiring the resources that would otherwise be required to maintain additional backups of the archived data for long periods of time.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a diagrammatic representation of one embodiment of an enterprise computing system 100 that includes data archiving.

FIG. 2A and FIG. 2B (collectively, FIG. 2) are diagrammatic representations of one embodiment of providing anti-attack protection for archived data.

FIG. 3 is a flow chart of one embodiment of providing anti-attack protection for archived data.

FIG. 4 is a diagrammatic representation of a distributed network environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

In general, data archiving refers to the movement or copying of data to separate storage for the general purpose of data retention. The storage used for archival data is often less expensive, but slower or more difficult to access, than the storage used for active data. As mentioned above, data archiving systems may use cloud storage for storing archival data.

Embodiments of the present disclosure generally pertain to methods and systems for protecting archival data from ransomware or other cyber-attacks. More particularly, embodiments relate to protecting archival data in cloud storage. Even more particularly, some embodiments relate to protecting archival data stored in third-party cloud storage systems.

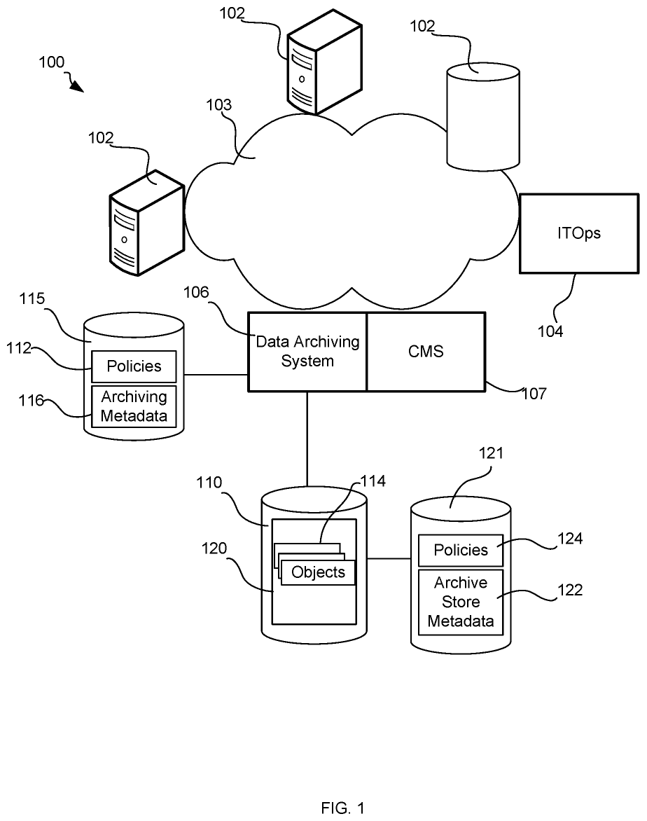

FIG. 1 is a diagrammatic representation of one embodiment of an enterprise computing system 100 that includes data archiving. In the embodiment illustrated, enterprise computing system 100 includes a plurality of storage components 102 that store structured or unstructured data relevant to the enterprise, such as content related to file systems and enterprise applications. A storage component may comprise any computer system that stores data, such as a client computer, a content management system, a file system, or a database to provide a few examples. Storage components are connected using a network 103, such as a Local Area Network (LAN), a Wide Area Network (WAN), the Internet, or the like. An information technology operations (ITOps) system 104 is connected to storage components 102 via the network and provides services for managing the IT infrastructure of network 103.

Data volume growth in an enterprise computing environment, such as enterprise computing system 100, can create compliance concerns and increase legal and business risks. However, resource requirements and storage costs make retaining all this data unviable. To help manage data, enterprise computing system 100 comprises a data archiving system 106. Data archiving system 106 is connected to storage components 102 and ITOps system 104 via network 103. In some embodiments, data archiving system 106 is provided by a content management system 107 that includes components to manage active files. According to one embodiment, data archiving system 106 and content management system 107 are implemented in software executed by one or more computer systems.

Data archiving system 106 implements policies 112 to identify data from storage components 102 based on criteria such as usage patterns, relevance, and regulatory requirements and stores the data as archival data to archive store 110. Archive store 110, according to one embodiment, is an object-based store that stores data items, such as files, as corresponding objects 114. The archival data stored in archive store 110 can include archival copies of data being worked on or actively updated in enterprise computing system 100 and archival copies of data that is no longer being worked on or has been removed from storage components 102. As will be appreciated, data archiving system 106 may include features to ensure data security and compliance, such as encryption, enforcement of retention policies, and lifecycle management of archival data.

In some embodiments, data archiving system 106 uploads files or other data items in their native format as archival data for storage in archive store 110. In other embodiments, data archiving system 106 stores data from storage components 102 to an archive format different from the native format. The archive format, for example, may be a format that compresses data, encrypts data, or combines several native data items together in a single archival file for upload.

Data archiving system 106 maintains an archiving system data store 115 that stores information used by data archiving system 106 for managing archival and retrieval of data. According to one embodiment, such information comprises archive metadata 116, archiving policies 112, and data that defines roles and permissions within the context of archiving. Archive metadata 116 provides data used to manage archiving and retrieval of archival data in archive store 110. Examples of archive metadata 116 for an archival file include, but are not limited to, native metadata of the file or files stored as the archival file or other metadata collected from storage components 102, a mapping of the native files to the archival files, the object id of the object in archive store 110 that stores the archival file, the archive policies 112 to which the archival file is subject, permission assignments for permissions enforced by data archiving system 106 for the archival file. Archive policies 112 include policies that define what data to store to archive store 110, retention policies defining how long archival data is to be retained, lifecycle policies that define how or when to dispose of archival data when the applicable retention period has expired, and other policies.

As discussed, archive store 110 may be a cloud storage system. Archive store 110 may provide various features for managing content stored on the cloud storage system, such as versioning and retention policies. To this end, archive store 110 maintains cloud storage management store 121 that includes archive storage metadata 122, policies 124, roles and permissions and other metadata used for managing a cloud storage system. Examples of archive storage metadata 122 include, but are not limited to, permission assignments for permissions enforced by archive store 110, versioning information, and metadata specifying policies applied to containers or objects. Policies 124 include, for example, versioning policies, retention policies, anti-attack policies, and lifecycle policies enforced by archive store 110.

Archive store 110, as discussed, supports versioning. As would be appreciated by those in the art, versioning functionality allows several copies of an item to be maintained as multiple versions of the same object. For example, file versioning allows multiple copies of a file to be maintained as different versions of the same file. The different versions are linked using versioning metadata.

One or more of the storage components 102 or content management system 107 can also support versioning. In accordance with one embodiment, data archiving system 106, stores each version of item, for versioning controlled by a storage component 102 or content management system 107, as a different object without using the versioning functionality of archive storage. From the perspective of archive store 110, each object 114 is a different object, even if multiple objects 114 store what, from the perspective of a storage component 102 or content management system 107, are different versions of the same item. For example, say content management system maintains a File1, version 1 and File1, version 2 as different versions of the same file and data archiving system 106 archives these versions, data archiving system 106 stores File1, version 1 as Object1 in archive store 110 and File1, version 2 as Object2 without using the versioning functionality of archive store 110. Thus, from the perspective of archive store 110, Object1 and Object2 are different objects and not versions of the same object. Moreover, in some embodiments, data archiving system 106 stores data to archive store 110 without applying a retention policy enforceable by archive storage. Instead, data archiving system 106 manages retention based on retention policies that are not propagated to archive store 110.

As will be appreciated, users of cloud storage systems typically store data to virtual containers associated with the user's account. Typically, an account holder can create multiple containers, specify who (e.g., what users or roles) can access the container, and enable certain functionality, such as versioning, on a per container basis. In the illustrated embodiment, data archiving system 106 is configured with credentials or other information to allow data archiving system 106 to access and store data to container 120. With respect to archival data, a user who may have permission to access the data when it is not archived (e.g., when access is controlled by a storage component 102 or content management system 107), may not have permission to access the archival version of the data.

According to one embodiment, the owner or user with sufficient permissions can configure an object with an anti-attack policy. In some embodiments, assigning an anti-attack policy to an object comprises configuring a container as an anti-attack container. For example, objects 114 may be configured with an anti-attack policy by virtue of being in container 120, where container 120 is configured as an anti-attack container. An anti-attack policy, according to one embodiment, comprises a versioning configuration and a retention policy. When an anti-attack policy is in force on an object and archive store 110 detects an attempted change to the object, archive store 110 automatically creates a new version of the object and places a retention lock on the old version according to the retention policy. The retention lock comprises a retention configuration that specifies how long the object will be retained. For example, the retention lock, in some embodiments, specifies a “retain until time” that indicates the date and time to which the object must be retained. If, for example, the retention policy specifies a time of 30 days, archive store 110 will set the retain until time to be 30 days from when the retention lock is set. The retention configuration may also control, for example, what changes can be made to the specification. For example, the retention configuration may specify that authorized users can change the retention configuration for an object or that the retention configuration cannot be changed for the object.

In one embodiment, the anti-attack policy may also specify a notification target. When the anti-attack policy is triggered by an edit to the object, archive storage sends a notification to the notification target. In one embodiment, the notification target is ITOps system 104, which is programmed with rules to take remedial action responsive to the notification. In one embodiment, the remedial action includes one or more of: blocking connections to archive store 110, scanning the relevant environment (e.g., enterprise computing system 100) for attacker code, investigating entry points where the attacker code came from, removing the attacker code, restoring the ‘current’ version of attacked objects from the ‘non-current’ version. Setting the system live again when the attacker code has been removed.

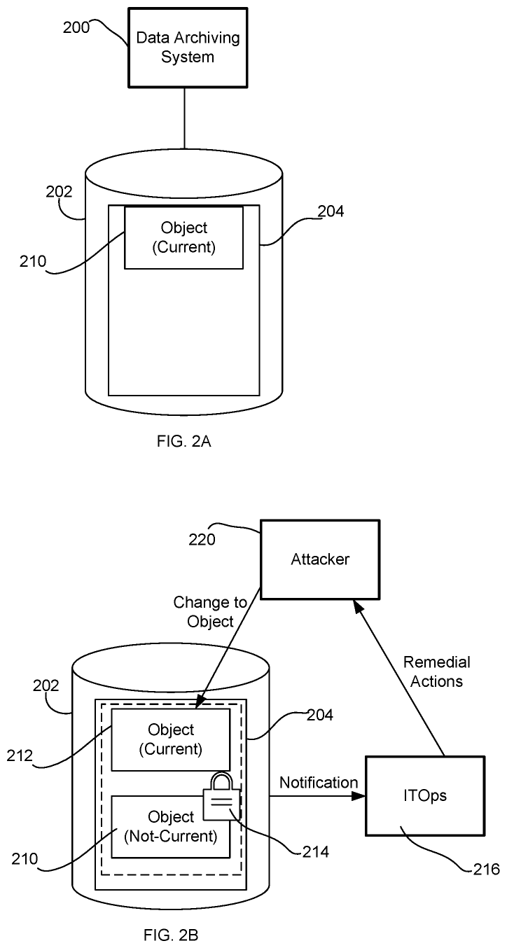

FIG. 2A and FIG. 2B (collectively, FIG. 2) are diagrammatic representations of one embodiment of providing anti-attack protection for archived data. In FIG. 2, a data archiving system 200, such as data archiving system 106 of FIG. 1, stores archival data to an anti-attack container 202 of an archive store 204. In one embodiment, archive store 204 comprises a cloud storage system. In an even more particular embodiment, archive store is a third-party cloud storage system provided by a different entity than controls data archiving system 200. Anti-attack container 202 has associated functionality enabled (e.g., via configuration, in some embodiments) comprising: when archive store 204 detects an attempted change to an object in anti-attack container 202, archive store 204 creates a new version of the object, and archive store 204 automatically applies a retention lock on the old version of the object.

In FIG. 2A, the data archiving system 200 creates an object 210 and stores data to be archived to the new object as archival data. For example, data archiving system 200 stores an archival document as an object 210 in anti-attack container 202. At this point, object 210 is the current object as it is the most current version of the object. Turning to FIG. 2B, attacker code 220 attempts to change the archival document in anti-attack container 202—for example, ransomware attempts to encrypt object 210. Archive store 204 stores the changed object 212 as a new version of the object and places a retention lock 214 on object 210, to which the change was not applied. Here, object 210 and object 212 are linked by archive store 204 as different versions of the same object. Object 212 is now the current version of the object and object 210 is an old (not current) version of the object.

Retention lock 214 comprises a retention configuration that specifies how long the object will be retained. For example, the retention lock, in some embodiments, specifies a “retain until time” that indicates the date and time to which the object must be retained. In some embodiments, the retention configuration is based on a policy assigned to anti-attack container 202. In general, the duration of the retention lock may be selected to allow recovery from the attack. Thus, the retention lock may specify a relatively short retention period (e.g., a week, 30 days, or another period). Retention lock 214 is enforced by archive store 204 rather than a retention policy enforced by data archiving system 200.

In some embodiments, the functionality associated with anti-attack container 202 further comprises archive store 204 sending a notification to a target, such as ITOps system 216, of a predefined event associated with the attempted change. In some embodiments, the predefined event comprises detecting an attempted change to an object in anti-attack container 202 or creating a new version of an object in anti-attack container 202. In one embodiment, for example, when archive store 204 creates object 212—i.e., the new version of object 210—archive store 204 sends a notification of the event to ITOps system 216. ITOps can take remedial action, such as, but not limited to: blocking connections to archive store 204 or anti-attack container 202, scanning the relevant environment for attacker code 220, investigating entry points for attacker code 220, removing attacker code 220, restoring the ‘current’ version of attacked objects from the ‘non-current’ version, setting the system live again when attacker code 220 has been removed. In one embodiment, for example, ITOps system deletes object 212, which makes object 210 the current version of the object again.

An attack may continue for some time before remedial action can be implemented. In such instances, attacker code 220 may attempt to change object 212, resulting in yet another version of the object being created. In some embodiments, archive store 204 limits the number of new versions of an object that can be created in anti-attack container 202, thereby preventing runaway chains of new versions being created. For example, archive store 204 may limit the system to creating only one new version of the object in archive store 204. In yet another embodiment, archive store 204 may limit the versions on which it places the retention lock. For example, archive store 204, according to one embodiment, is configured to only place the retention lock on one version of an object. Thus, even if there is a chain of newer versions created in an attack, the remedial action can still delete the new versions.

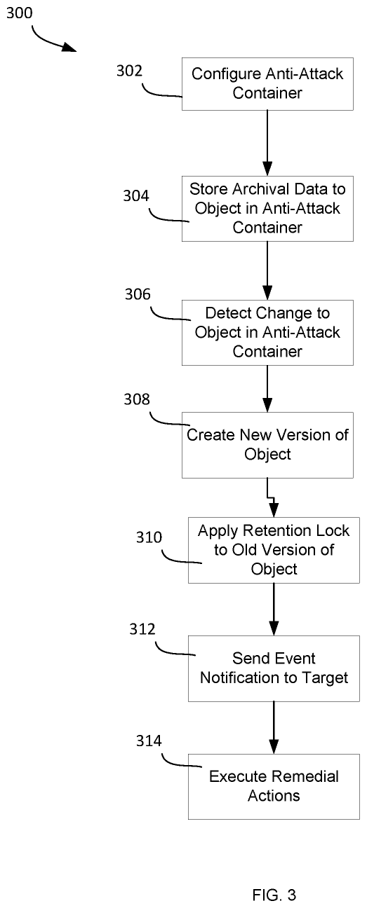

FIG. 3 is a flow chart illustrating one embodiment of a method 300 for providing anti-attack protection for archived data. In some embodiments, method 300 of FIG. 3 is embodied as computer-executable instructions on a non-transitory computer readable medium. In even more particular embodiments, steps FIG. 3 are implemented by a data archiving system, a cloud storage system, and an ITOps system.

At step 302, an anti-attack storage container is configured at an archive store for a data archiving system. Configuring the anti-attack container may include, for example, setting permissions to allow the data archiving system to store and retrieve data from the container and enabling anti-attack functionality. Enabling anti-attack functionality includes, in one embodiment, enabling versioning on the container and enabling the setting of retention locks on old versions of objects in the anti-attack container when new versions of the objects are created. Configuring the anti-attack container includes, in some embodiments, specifying the retention policy to be applied to old versions of objects in the anti-attack container and setting a target for predefined event notifications with respect to events on objects in the anti-attack container. According to one embodiment, the archive store is a cloud storage system and the anti-attack container is a cloud storage container provided by the cloud storage system.

At step 304, the data archiving system creates a new object in the anti-attack container and stores archival data to the object.

At step 306, the archive store detects an attempted change to the object and executes the enabled anti-attack functionality. For example, at step 308, the archive store creates a new version of the object in the anti-attack container and saves the changes to the new version of the object. When the new version of the object is created, the new version becomes the current version and the prior version becomes the old version.

At step 310, the archive store applies a retention lock to the old version of the object. The retention lock specifies a retention period for which the older version of the object is to be retained. The retention period, according to one embodiment, is based on a retention policy associated with the anti-attack container. In another embodiment, the retention period is a default retention period.

At step 312, the archive store sends a notification of an event associated with the object to a target. For example, in one embodiment, the archive store sends a notification that the archive store has created a new version of the object. In one embodiment, the target is an ITOps system or other system that can execute remedial action.

At step 314, remedial action is executed. The remedial action, according to one embodiment, comprises at least one of blocking connections to the archive store or anti-attack container, scanning the relevant environment for attacker code, investigating entry points for the attacker code, removing the attacker code, restoring the ‘current’ version of attacked objects from a ‘non-current’ version, or setting the system live again when attacker code has been removed.

FIG. 3 is merely an illustrative example, and the disclosed subject matter is not limited to the ordering or number of steps illustrated. Embodiments may implement additional steps or alternative steps, omit steps, or repeat steps.

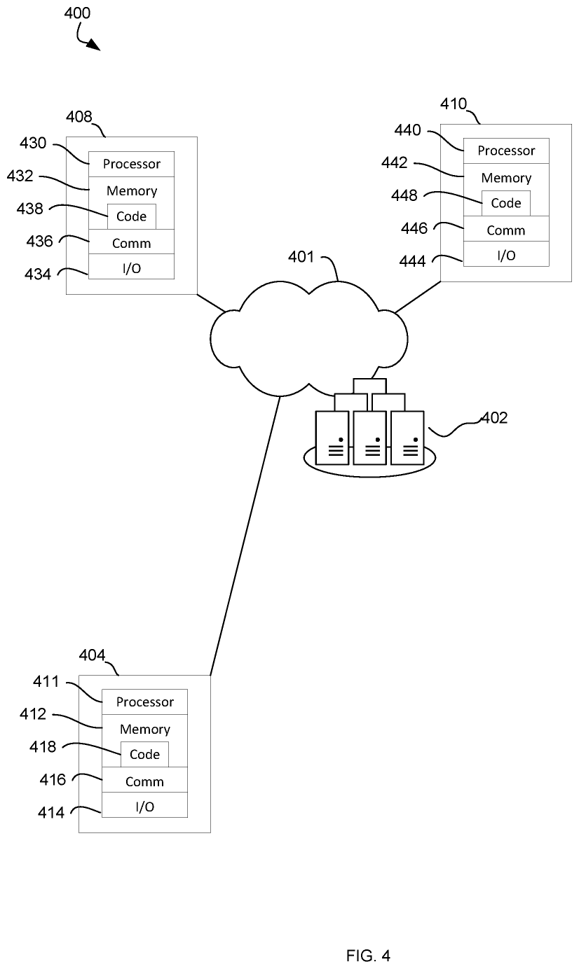

FIG. 4 is a diagrammatic representation of one embodiment of a distributed network computing environment 400. In the example illustrated, network computing environment 400 includes network 401 that is bi-directionally coupled to storage components 402, a data archiving computer system 404, and an ITOps computer system 408. Data archiving computer system 404 and ITOps computer system 408 are connected to an archive store 410 via the Internet.

Storage components 402 are computer systems with related processors, memories and interfaces that store relevant data. Data archiving computer system 404 comprises a computer processor 411 and associated memory 412. Computer processor 411 may be an integrated circuit for processing instructions, such as, but not limited to a central processing unit (CPU). Memory 412 may include volatile memory, non-volatile memory, semi-volatile memory or a combination thereof. Memory 412, for example, may include RAM, ROM, flash memory, a hard disk drive, a solid-state drive, an optical storage medium (e.g., CD-ROM), or other computer readable memory or combination thereof. Memory 412 implements a storage hierarchy that includes cache memory, primary memory and secondary memory. In some embodiments, memory 412 includes storage space on a data storage array. Data archiving computer system 404 may also include input/output (“I/O”) devices 414, such as a keyboard, monitor, printer, electronic pointing device (e.g., mouse, trackball, stylus, etc.), or the like, and a communication interface 416, such as a network interface card, to interface with network 401. Data archiving computer system 404 includes executable instructions 418 stored on a non-transitory computer readable medium coupled to computer processor 411. The computer executable instructions of data archiving computer system 404 are executable to provide a data archiving system, such as data archiving system 106 or data archiving system 200.

ITOps computer system 408 comprises a computer processor 430 and associated memory 432. Computer processor 430 may be an integrated circuit for processing instructions, such as, but not limited to a CPU. Memory 432 may include volatile memory, non-volatile memory, semi-volatile memory or a combination thereof. Memory 432, for example, may include RAM, ROM, flash memory, a hard disk drive, a solid-state drive, an optical storage medium (e.g., CD-ROM), or other computer readable memory or combination thereof. Memory 432 implements a storage hierarchy that includes cache memory, primary memory and secondary memory. In some embodiments, memory 432 includes storage space on a data storage array. ITOps computer system 408 may also include input/output devices 434, such as a keyboard, monitor, printer, electronic pointing device (e.g., mouse, trackball, stylus, etc.), or the like, and a communication interface 436, such as a network interface card, to interface with network 401.

ITOps computer system 408 includes executable instructions 438 stored on a non-transitory computer readable medium coupled to computer processor 430. The computer executable instructions of ITOps computer system 408 are executable to receive notifications from archive store 410 and implement remedial actions.

Archive store 410 comprises a computer processor 440 and associated memory 442. Computer processor 440 may be an integrated circuit for processing instructions, such as, but not limited to a CPU. Memory 442 may include volatile memory, non-volatile memory, semi-volatile memory or a combination thereof. Memory 442, for example, may include RAM, ROM, flash memory, a hard disk drive, a solid-state drive, an optical storage medium (e.g., CD-ROM), or other computer readable memory or combination thereof. Memory 442 implements a storage hierarchy that includes cache memory, primary memory and secondary memory. In some embodiments, memory 442 includes storage space on a data storage array. Data archiving computer system 404 may also include input/output devices 444, such as a keyboard, monitor, printer, electronic pointing device (e.g., mouse, trackball, stylus, etc.), or the like, and a communication interface 446, such as a network interface card, to interface with network 401.

Archive store 410 includes executable instructions 448 to provide an archive store such as archive store 110 or archive store 204. More particularly, executable instructions 418 are executable to provide an anti-attack container and anti-attack functionality. In some embodiments, archive store 410 is a cloud storage system.

While the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. For example, it will be understood that while embodiments as discussed herein are presented in the context of a browser-based application other embodiments may be applied with equal efficacy to other types of components on computing devices (e.g., other native components, etc.).

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a CPU, read-only memory (“ROM”), random access memory, secondary storage, input/output device(s), and interfaces.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein. Functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the otherwise (i.e., that the reference “a” or “an” clearly indicates only the singular or only the plural).

What is claimed is:

1. A computer-implemented method for protection of archival data, comprising:
creating a first version of an object in an anti-attack store;
storing an archival file in the object in the anti-attack store, wherein the anti-attack store has associated anti-attack functionality triggerable based on detecting an attempted change to the object in the anti-attack store enabled, the associated anti-attack functionality comprising:
automatically creating a new version of the object; and
automatically applying a retention lock to the first version of the object without applying the attempted change to the first version of the object, the retention lock specifying a retention period for the first version of the object.

2. The computer-implemented method of claim 1, wherein the associated anti-attack functionality further comprises:
sending a notification of an event associated with the attempted change to a target.

3. The computer-implemented method of claim 2, wherein the notification of the event associated with the attempted change comprises a notification that the new version of the object has been created.

4. The computer-implemented method of claim 2, wherein the notification of the event associated with the attempted change triggers a remedial action, and wherein the remedial action comprises at least one of:
blocking a connection;
scanning an environment for attacker code;
investigating entry points for attacker code;
removing the attacker code;
restoring the first version of the object as a current version of the object; or
deleting the new version of the object.

5. The computer-implemented method of claim 1, wherein the anti-attack store comprises an anti-attack container on a cloud storage system.

6. The computer-implemented method of claim 1, wherein the attempted change is made to the new version of the object.

7. A computer-implemented method for protection of archival data, comprising:
creating a first version of an object in an anti-attack store;
storing an archival file in the object in the anti-attack store;
detecting an attempted change to the object;
based on detecting the attempted change to the object, protecting the object from a potential cyber-attack, wherein protecting the object from the potential cyber-attack comprises:
automatically creating a new version of the object in the anti-attack store; and
automatically applying a retention lock to the first version of the object without applying the attempted change to the first version of the object, the retention lock specifying a retention period for the first version of the object.

8. The computer-implemented method of claim 7, further comprising applying the attempted change to the new version of the object.

9. The computer-implemented method of claim 7, wherein protecting the object from the potential cyber-attack further comprises sending a notification of an event associated with the attempted change to a target.

10. The computer-implemented method of claim 9, wherein the notification of the event associated with the attempted change comprises a notification that the new version of the object has been created.

11. The computer-implemented method of claim 9, wherein the notification of the event associated with the attempted change triggers a remedial action, and wherein the remedial action comprises at least one of:
blocking a connection;
scanning an environment for attacker code;
investigating entry points for attacker code;
removing the attacker code;
restoring the first version of the object as a current version of the object; or
deleting the new version of the object.

12. The computer-implemented method of claim 7, wherein the anti-attack store comprises an anti-attack container of a cloud storage system.

13. A non-transitory, computer-readable medium storing computer-translatable instructions, the computer-translatable instructions comprising instructions for:
creating a first version of an object in an anti-attack store;
storing an archival file in the object in the anti-attack store, where the anti-attack store has associated anti-attack functionality triggerable based on detecting an attempted change to the object in the anti-attack store enabled, the associated anti-attack functionality comprising:
automatically creating a new version of the object; and
automatically applying a retention lock to the first version of the object without applying the attempted change to the first version of the object, the retention lock specifying a retention period for the first version of the object.

14. The non-transitory, computer-readable medium of claim 13, wherein the associated anti-attack functionality further comprises:
sending a notification of an event associated with the attempted change to a target.

15. The non-transitory, computer-readable medium of claim 14, wherein the notification of the event associated with the attempted change comprises a notification that the new version of the object has been created.

16. The non-transitory, computer-readable medium of claim 14, wherein the notification of the event associated with the attempted change triggers a remedial action, and wherein the remedial action comprises at least one of:
blocking a connection;
scanning an environment for attacker code;
investigating entry points for attacker code;
removing the attacker code;
restoring the first version of the object as a current version of the object; or
deleting the new version of the object.

17. The non-transitory, computer-readable medium of claim 14, wherein the anti-attack store comprises an anti-attack container on a cloud storage system.

18. A network system for data archiving comprising:
a storage component;
a data archiving computer system coupled to the storage component, the data archiving computer system comprising a data archiving system executable to:
access an anti-attack container of a cloud storage system; and
store an archival file as a first version of an object in the anti-attack container, the anti-attack container having associated anti-attack functionality triggerable based on an attempted change to the object, the associated anti-attack functionality comprising:
automatically creating a new version of the object in the anti-attack container; and
automatically applying a retention lock to the first version of the object without applying the attempted change to the first version of the object, the retention lock specifying a retention period for the first version of the object.

19. The network system of claim 18, further comprising an information technology operations system comprising instructions executable to:
receive a notification from the cloud storage system of an event associated with the object;
execute a remedial action in response to the notification.

20. The network system of claim 19, wherein the remedial action comprises at least one of:
blocking a connection;
scanning an environment for attacker code;
investigating entry points for attacker code;
removing the attacker code;
restoring the first version of the object as a current version of the object; or
deleting the new version of the object.
